(19) United States
(12) Patent Application Publication
(10) Pub. No.: US 2012/0069319 A1
(43) Pub. Date: Mar. 22, 2012

(54) BEAM IRRADIATION DEVICE AND LASER RADAR SYSTEM

(75) Inventors: Yoshiaki Maeno, Mizuho-Shi (JP); Masato Yamada, Inuyama-Shi (JP)

(73) Assignee: SANYO Electric Co., Ltd., Moriguchi-shi (JP)

(21) Appl. No.: 13/234,291

(22) Filed: Sep. 16, 2011

(30) Foreign Application Priority Data
Sep. 16, 2010 (JP) 2010-208525

(51) Int. Cl. G01S 17/06

(52) U.S. Cl. 356/4.01

(57) ABSTRACT

A beam irradiation device is provided with a laser light source which emits laser light, a mirror actuator which causes the laser light to scan a targeted area, and an emission window through which laser light reflected on a mirror of the mirror actuator is transmitted. The emission window is formed with an anti-reflection film for suppressing surface reflection. The anti-reflection film has an angle dependence such that a lower limit of a reflectance is maintained in an incident angle range (0 to 20°) of the laser light at least corresponding to a scanning range of the laser light.

This application claims priority under 35 U.S.C. Section 119 of Japanese Patent Application No. 2010-208525 filed Sep. 16, 2010, entitled “BEAM IRRADIATION DEVICE AND LASER RADAR SYSTEM”. The disclosure of the above application is incorporated herein by reference.

### BACKGROUND OF THE INVENTION

1. Field of the Invention

The present invention relates to a beam irradiation device for irradiating a targeted area with laser light, and a laser radar system for detecting a condition of a targeted area based on reflected light of laser light with respect to the targeted area.

2. Disclosure of Related Art

In recent years, a laser radar system has been loaded in a family automobile or a like vehicle to enhance security in driving. Generally, the laser radar system is so configured as to scan a targeted area with laser light to detect presence or absence of an obstacle at each of scanning positions, based on presence or absence of reflected light at each of the scanning positions. The laser radar system is also configured to detect a distance to the obstacle at each of the scanning positions, based on a required time from an irradiation timing of laser light to a light receiving timing of reflected light at each of the scanning positions.

A beam irradiation device is loaded in a laser radar system to scan a targeted area with laser light. In the above arrangement, it is possible to use an actuator which drives a mirror into which laser light is entered about two axes, or an actuator which drives a lens for transmitting laser light, as an arrangement for scanning a targeted area with laser light. Alternatively, laser light may be scanned using a polygonal mirror.

Laser light is irradiated onto a targeted area, with a predetermined shape. The beam irradiation device is provided with a lens for shaping laser light into an intended shape. It is desirable to irradiate laser light onto the targeted area in a state that a boundary of laser light is clearly recognized, in other words, in a state that the light intensity is sharply decreased at a boundary portion of laser light. The lens for shaping laser light is so designed as to make optical characteristics (beam profile) of laser light satisfactory in the targeted area.

Normally, the beam irradiation device is housed in a housing to be shielded from the outside. A transparent emission window for transmitting laser light of a use wavelength is formed in the housing, and laser light is projected onto a targeted area through the emission window. Accordingly, characteristics of laser light in the targeted area are affected by the characteristics of the emission window to some extent. If the characteristics of the emission window are poor, optical characteristics (beam profile) of laser light in the targeted area may be degraded, even if the characteristics of the beam shaping lens are enhanced.

### SUMMARY OF THE INVENTION

A first aspect of the invention relates to a beam irradiation device. The beam irradiation device according to the first aspect includes a laser light source which emits laser light; an actuator which causes the laser light to scan a targeted area; and an emission window through which the laser light via the actuator is transmitted. The emission window is formed with reflection suppressing means for suppressing surface reflection.

A second aspect of the invention relates to a laser radar system. The laser radar system according to the second aspect includes the beam irradiation device according to the first aspect, and a light receiving portion which receives laser light reflected on the targeted area.

### BRIEF DESCRIPTION OF THE DRAWINGS

FIGS. 1A and 1B are diagrams respectively showing an arrangement of a laser radar system embodying the invention.

FIG. 2 is a diagram showing an arrangement of a mirror actuator in the embodiment.

FIGS. 3A and 3B are diagrams showing a process of assembling the mirror actuator in the embodiment.

FIGS. 4A and 4B are diagrams showing a process of assembling the mirror actuator in the embodiment.

FIG. 5 is a diagram showing an arrangement of a beam irradiation device embodying the invention.

FIGS. 6A and 6B are diagrams for describing an arrangement and an operation of a servo optical system in the embodiment.

FIGS. 7A and 7B are diagrams showing an arrangement of an emission window and characteristics of an anti-reflection film in the embodiment.

FIG. 8 is a diagram showing characteristics of the anti-reflection film in the embodiment.

FIGS. 9A and 9B are diagrams showing a measurement result verifying characteristics of the emission window in the embodiment.

FIGS. 10A through 10C are diagrams showing a method for measuring characteristics of the emission window in the embodiment.

FIGS. 11A through 11D are diagrams showing an arrangement of the emission window, as a modification of the embodiment.

FIG. 12 is a diagram for describing an operation of a periodic structure of the emission window in the modification.

### DESCRIPTION OF PREFERRED EMBODIMENTS

In the following, an embodiment of the invention is described referring to the drawings.

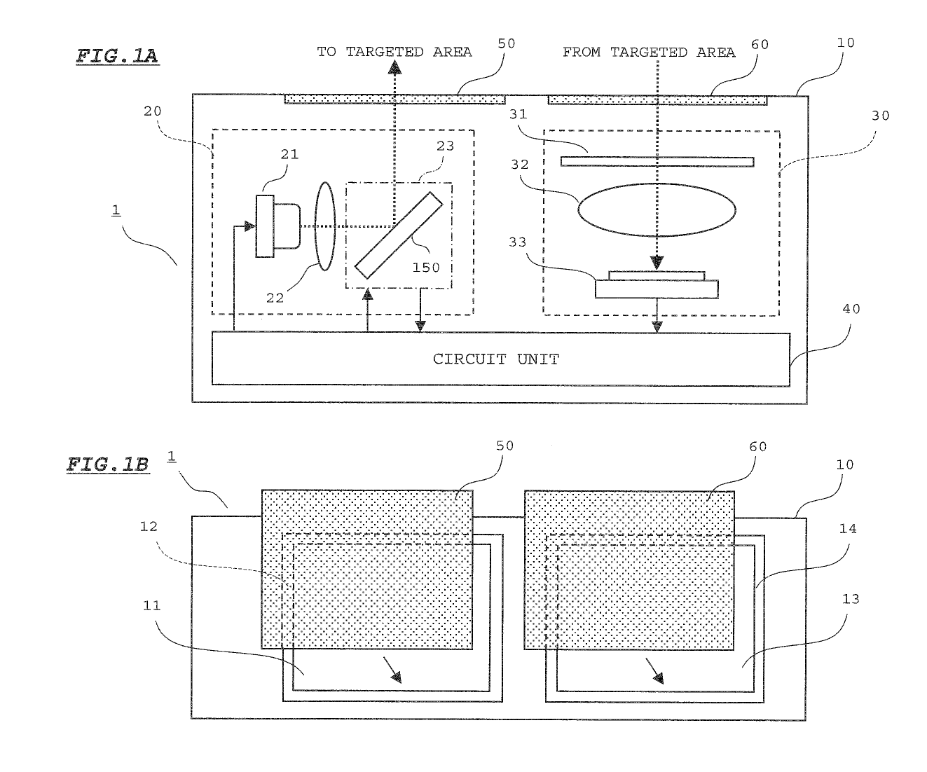

FIGS. 1A, 1B are diagrams schematically showing an arrangement of a laser radar system 1 embodying the invention. FIG. 1A is a top plan perspective view of the inside of the laser radar system 1, and FIG. 1B is a front view of the laser radar system 1 in a state before an emission window 50 and a light receiving window 60 are mounted.

Referring to FIG. 1A, the laser radar system 1 is provided with a housing 10, a projection optical system 20, a light receiving optical system 30, a circuit unit 40, the emission window 50, and the light receiving window 60. In this embodiment, a portion constituted of the housing 10, the projection optical system 20, a circuit section of the circuit unit 40 relating to light projection, and the emission window 50 corresponds to a beam irradiation device in the claims. In this embodiment, both of the arrangement (beam irradiation device) relating to light projection, and the arrangement relating to light receiving are housed in the housing 10. Alternatively, the laser radar system 1 may be configured such that these two arrangements are housed in individual housings, and are electrically connected to each other.

The housing 10 has a cubic shape, and houses therein the projection optical system 20, the light receiving optical system 30, and the circuit unit 40. As shown in FIG. 1B, openings 11, 13 are formed in a front surface of the housing 10, and recess portions 12, 14 for receiving the emission window 50 and the light receiving window 60 are respectively formed in the peripheries of the openings 11, 13. The emission window 50 and the light receiving window 60 are respectively mounted on the front surface of the housing 10 by receiving and fixing the peripheries of the emission window 50 and the light receiving window 60 in the recess portions 12, 14 by adhesion.

The projection optical system 20 is provided with a laser light source 21, a beam shaping lens 22, and a mirror actuator 23.

The laser light source 21 emits laser light of a wavelength of or about 900 nm.

The beam shaping lens 22 converges laser light in such a manner that laser light emitted from the laser light source 21 has a predetermined shape in a targeted area. For instance, the beam shaping lens 22 is designed in such a manner that the beam shape in a targeted area (which is located at a position ahead of a beam output port of the beam irradiation device by about 100 m in this embodiment) has an elliptical shape of about 2 m in longitudinal direction and about 0.2 m in transverse direction.

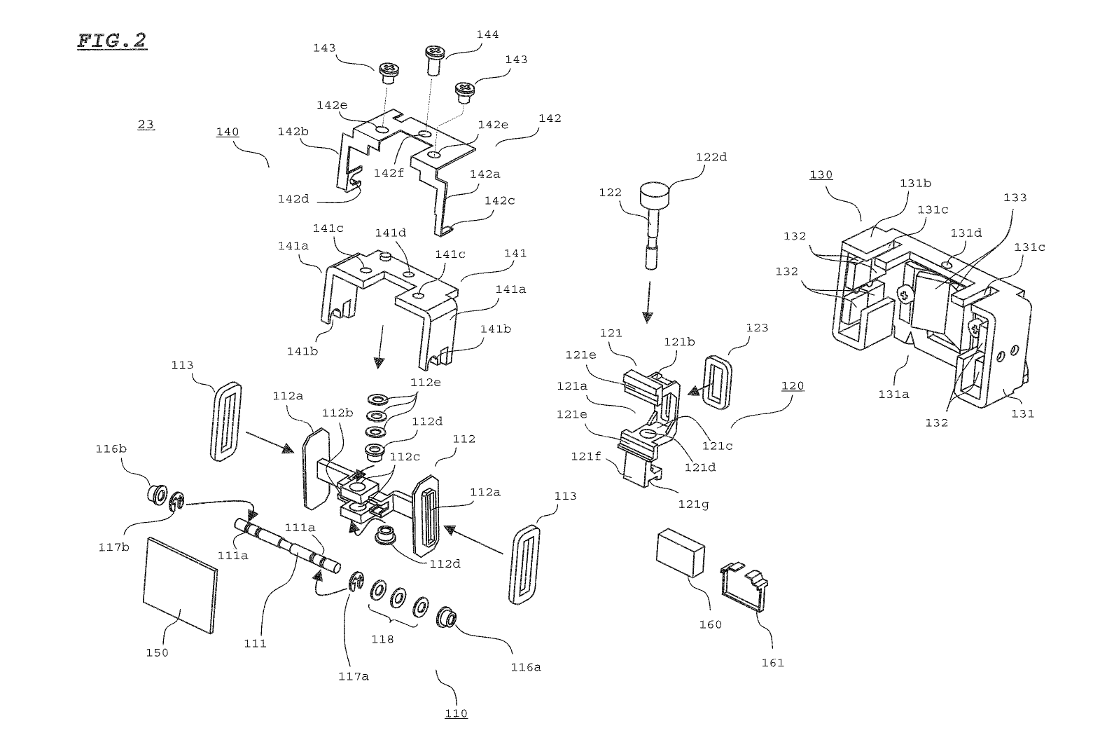

The mirror actuator 23 is provided with a mirror 150 into which laser light transmitted through the beam shaping lens 22 is entered, and a mechanism for rotating the mirror 150 about two axes. Laser light is scanned in a targeted area by rotating the mirror 150. The details of the mirror actuator 23 will be described later referring to FIGS. 2 through 6B.

The light receiving optical system 30 is provided with a filter 31, a light receiving lens 32, and a photodetector 33. The filter 31 is a band-pass filter which transmits only light of a wavelength region of laser light to be emitted from the laser light source 21. The light receiving lens 32 collects light reflected on a targeted area. The photodetector 33 is constituted of an avalanche photodiode (APD) or a PIN photodiode, and outputs an electrical signal of a magnitude corresponding to the received light amount, to the circuit unit 40.

The circuit unit 40 is provided with e.g. a CPU and a memory, and controls the laser light source 21 and the mirror actuator 23. Further, the circuit unit 40 determines presence or absence of an obstacle in a targeted area, and measures a distance to the obstacle, based on a signal from the photodetector 33. Specifically, laser light is emitted from the laser light source 21 at a predetermined scanning position in a targeted area. In response to output of a signal from the photodetector 33, the photodetector 33 detects presence of an obstacle at the scanning position. Further, a distance to the obstacle is measured based on a time difference between a timing at which laser light is emitted and a timing at which a signal is outputted from the photodetector 33 at the scanning position.

The emission window 50 is constituted of a transparent flat plate having a uniform thickness. The emission window 50 is configured to suppress degradation of optical characteristics of laser light when the laser light transmitted from the side of the mirror actuator 23 is transmitted through the emission window 50. Specifically, the emission window 50 is made of a material having a high transparency, and the surface roughness and the haze value of the emission window 50 are set to small values to prevent light scattering on the incident surface and the output surface of the emission window 50. Further, an anti-reflection film (AR coat) is formed on each of the incident surface and the output surface of the emission window 50 to prevent internal reflection of the emission window 50.

Examples of the material composing the emission window 50 are cycloolefin polymer and polycycloolefin polymer. For instance, polymers under the trade names of “ZEONEX 480R”, “ZEONEX E48R”, “ZEONEX 330R”, “ZEONOR 1430R” of ZEON CORPORATION may be used as the material for the emission window 50.

As described above, the emission window 50 is configured in such a manner that the surface roughness and the haze value of the laser light incident surface and the laser light output surface thereof are set to small values in order to prevent laser light scattering. Laser light scattering on the incident surface or the output surface is maximized when the height of a projection or a recess on the incident surface or the output surface is set to one-half of the wavelength of laser light, and is sharply decreased, as the height of a projection or a recess is smaller than one-half of the wavelength. In view of the above, in this embodiment, the surface roughness (Rmax) of the incident surface and the output surface is set to a value smaller than 900 nm/2=450 nm, and is set to e.g. 300 nm or less. Further, the haze value is set to 2% or less.

Configuring the emission window 50 as described above enables to suppress degradation of optical characteristics of laser light when the laser light is transmitted through the emission window 50.

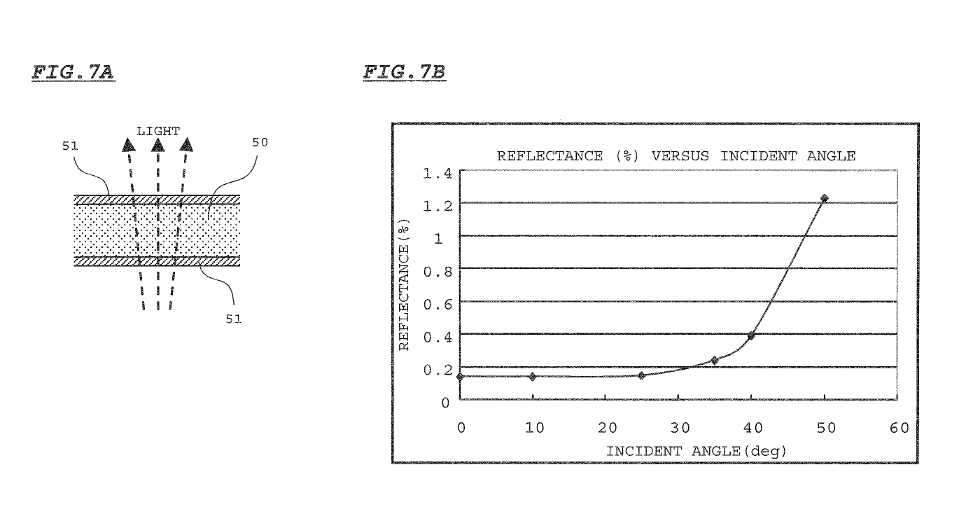

Further, in this embodiment, an anti-reflection film (AR coat) is formed on each of the incident surface and the output surface of the emission window 50. With this arrangement, it is possible to more effectively suppress degradation of optical characteristics of laser light. The characteristics and the effects of the anti-reflection film (AR coat) will be described later referring to FIGS. 7A through 10C.

In this embodiment, the light receiving window 60 is configured in the same manner as the emission window 50. With this arrangement, it is possible to more efficiently guide weak laser light reflected on a targeted area to the photodetector 33.

FIG. 2 is an exploded perspective view showing an arrangement of a mirror actuator 23 in the second embodiment of the invention.

The mirror actuator 23 is provided with a tilt unit 110, a pan unit 120, a magnet unit 130, a yoke unit 140, a mirror 150, and a transparent plate 160.

The tilt unit 110 is provided with a support shaft 111, a tilt frame 112, and two tilt coils 113. The support shaft 111 is formed with grooves 111a near both ends of the support shaft 111. E-rings 117a and 117b are mounted in the respective grooves 111a.

The tilt frame 112 is formed with coil mounting portions 112a at left and right ends thereof for mounting the tilt coils 113. The tilt frame 112 is further formed with a groove 112b for engaging the support shaft 111, and vertically aligned two holes 112c.

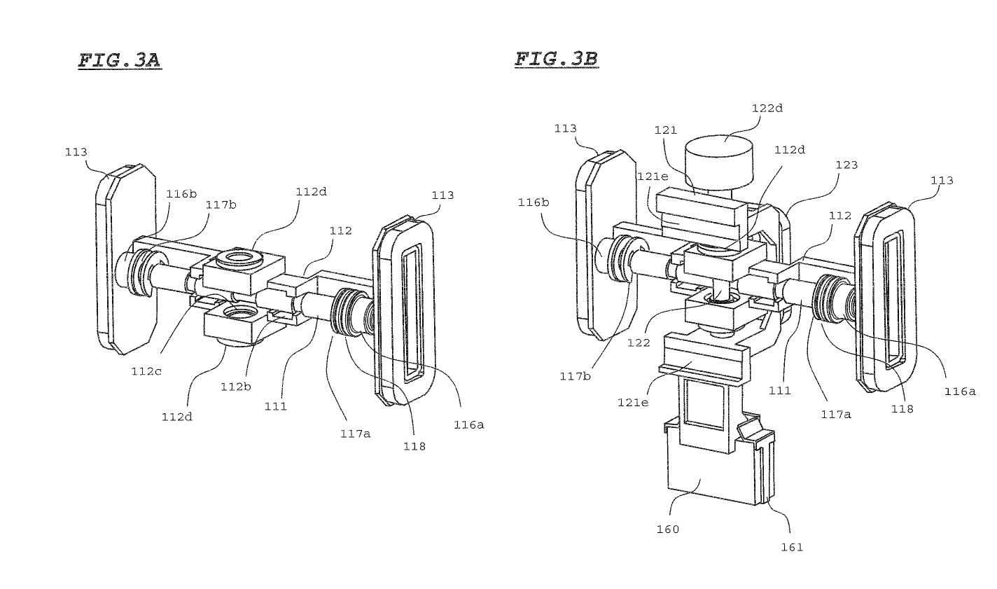

The support shaft 111 is engaged in the groove 112b formed in the tilt frame 112, and adhesively fixed to the tilt frame 112 in a state that bearings 116a and 116b, the E-rings 117a and 117b, and polyslider washers 118 are mounted on both side of the support shaft 111. Further, bearings 112d are mounted in the two holes 112c in the tilt frame 112 from an upper direction and a lower direction. With this operation, as shown in FIG. 3A, assembling of the tilt unit 110 is completed. FIG. 3A shows a state that the bearings 116a and 116b, the E-rings 117a and 117b, and the three polyslider washers 118 are mounted on the support shaft 111.

The pan unit 120 is mounted on the assembled tilt unit 110 in the manner as described below. Thereafter, the tilt unit 110 is attached to a yoke 141 in the manner as described below, using the bearings 116a and 116b, the E-rings 117a and 117b, the polyslider washers 118, and a shaft fixing member 142.

Referring back to FIG. 2, the pan unit 120 is provided with a pan frame 121, a support shaft 122, and a pan coil 123. The pan frame 121 is formed with an upper plate portion 121b and a lower plate portion 121c, with a recess portion 121a being formed therebetween. The upper plate portion 121b and the lower plate portion 121c are formed with vertically aligned through-holes 121d for passing the support shaft 122. Further, a step portion 121e is formed on a front surface of each of the upper plate portion 121b and the lower plate portion 121c for placing a mirror 150.

Further, a downwardly extending leg portion 121f is formed on the lower plate portion 121c, and a recess portion 121g for receiving a transparent plate 160 is formed in the leg portion 121f. The transparent plate 160 is mounted in the recess portion 121g from beneath the recess portion 121g, and the transparent plate 160 is fixed to the leg portion 121f of the pan frame 121 by a transparent plate fixing bracket 161. A balancer 122d is attached to an upper end of the support shaft 122.

The magnet unit 130 is provided with a frame 131, two pan magnets 133, and eight tilt magnets 132. The frame 131 has such a shape that a recess portion 131a is formed on the front side thereof. An upper plate portion 131b of the frame 131 is formed with horizontally extending two cutaways 131c, and is further formed with a screw hole 131d in the middle thereof. The eight tilt magnets 132 are mounted in upper and lower two rows on the left and right inner surfaces of the frame 131. Further, as shown in FIG. 2, the two pan magnets 133 are mounted on the rear inner surface of the frame 131 with a certain inward inclination.

The yoke unit 140 is provided with the yoke 141 and the shaft fixing member 142. The yoke 141 is constituted of a magnetic member. The yoke 141 is formed with wall portions 141a at left and right sides thereof, and recess portions 141b for mounting the support shaft 111 of the tilt unit 110 are formed in respective lower ends of the wall portions 141a. The yoke 141 is formed with vertically extending two screw through-holes 141c in an upper portion thereof, and is further formed with a screw hole 141d at a position corresponding to the screw hole 131d of the magnet unit 130. The distance between the inner side surfaces of the two wall portions 141a is set larger than the distance between the two grooves 111d of the support shaft 111.

The shaft fixing member 142 is a thin plate metal member having flexibility. Plate spring portions 142a and 142b are formed on a front portion of the shaft fixing member 142. Receiving portions 142c and 142d for restricting falling of the bearings 116a and 116b of the tilt unit 110 are formed on respective lower ends of the plate spring portions 142a and 142b. Further, an upper plate portion of the shaft fixing member 142 is formed with holes 142e at positions corresponding to the two screw holes 141c of the yoke 141, and is further formed with a hole 142f at a position corresponding to the screw hole 141d of the yoke 141.

In assembling the mirror actuator 23, the tilt unit 110 shown in FIG. 3A is assembled in the manner as described above. Thereafter, the tilt frame 112 is housed in the recess portion 121a of the pan frame 121. In performing the above operation, the pan frame 121 is positioned so that the two bearings 112d, three polyslider washers 112e and holes 121d in the pan frame 121 are vertically aligned. Then, in this state, the support shaft 122 is passed through two bearings 112d, and the hole 121d in the pan frame 121; and then, is fixed to the pan frame 121 by an adhesive. With the above operation, the structure body shown in FIG. 3B is formed. In this state, the pan frame 121 is pivotally movable around the support shaft 122, and is slightly movable up and down along the support shaft 122.

After the pan unit 120 is mounted as described above, the mirror 150 is placed in the step portions 121e of the pan frame 121, and fixed thereat. Thereafter, the bearings 116a and 116b mounted on both ends of the support shaft 111 of the tilt unit 110 are placed in the recess portions 141b of the yoke 141 shown in FIG. 2. Then, in this state, the shaft fixing member 142 is mounted on the yoke 141 so that the bearings 116a and 116b do not fall from the recess portions 141a, 141b. Specifically, the shaft fixing member 142 is mounted on the yoke 141 in such a manner that the receiving portion 142c holds the bearing 116a from below, and that the receiving portion 142d holds the bearing 116b from the front side of the mirror actuator 23. In this state, two screws 143 are fastened into the screw holes 141c of the yoke 141 through the two holes 142e of the shaft fixing member 142. Thereby, a structure member shown in FIG. 3B is mounted on the yoke unit 140.

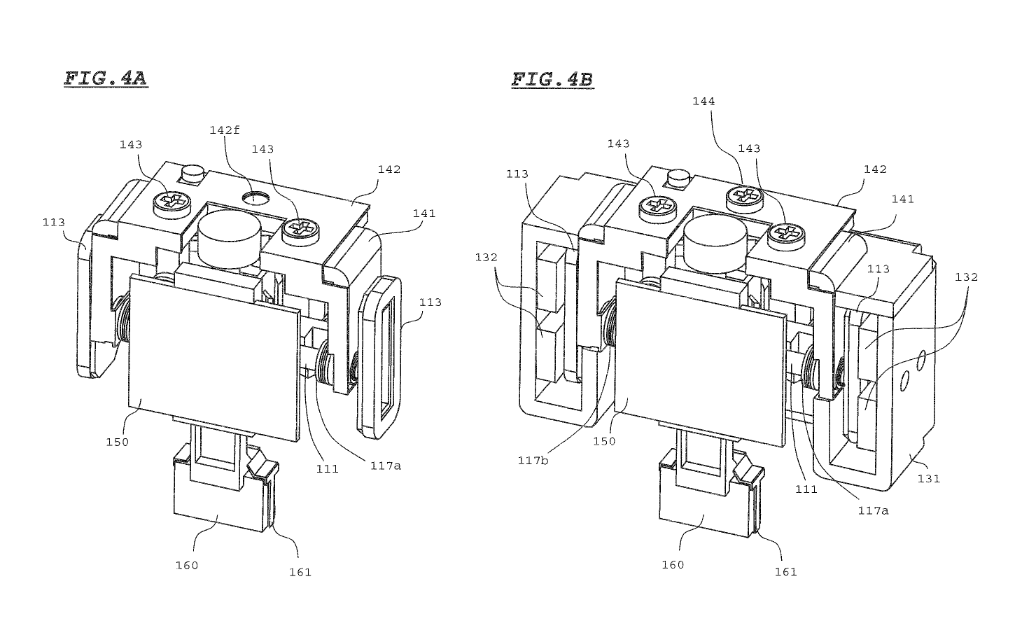

In this way, a structure member shown in FIG. 4A is assembled. In this state, the tilt frame 112 is pivotally movable about the support shaft 111 with the pan frame 121.

The assembled structure member shown in FIG. 4A is mounted on the magnet unit 130 in such a manner that the two wall portions 141a of the yoke 141 are respectively inserted in the cutaways 131c of the frame 131 of the magnet unit 130. Then, in this state, a screw 144 is fastened into the screw hole 141d of the yoke 141 and in the screw hole 131d of the magnet unit 130 through the hole 142f of the shaft fixing member 142. With this operation, the structure member shown in FIG. 4A is fixedly mounted to the magnet unit 130. Thus, assembling the mirror actuator 23 is completed, as shown in FIG. 4B.

In the assembled state shown in FIG. 4B, when the pan frame 121 is pivotally moved about the support shaft 122, the mirror 150 is also pivotally moved with the pan frame 121. Further, when the tilt frame 112 is pivotally moved about the support shaft 111, the pan unit 120 is pivotally moved with the tilt frame 112, and the mirror 150 is pivotally moved with the pan unit 120. In this way, the mirror 150 is supported on the support shafts 111 and 122 orthogonal to each other to be pivotally movable, and is pivotally moved about the support shafts 111 and 122 by energization of the tilt coils 113 and the pan coil 123. At the same time, the transparent plate 160 mounted on the pan unit 120 is pivotally moved in accordance with the pivotal rotation of the mirror 150.

The balancer 122d is adapted to adjust pivotal movement of the structure member shown in FIG. 3B about the support shaft 111 in a well-balanced manner. The balancing of pivotal movement is adjusted by the weight of the balancer 122d. Alternatively, as far as the balancer 122d is vertically displaceable, it is possible to adjust the balancing of pivotal movement by finely adjusting the position of the balancer 122d in a vertical direction.

In the assembled state shown in FIG. 4B, the dispositions and the polarities of the eight magnets 132 are adjusted so that a force for pivotally moving the tilt frame 112 about the support shaft 111 is generated by application of a current to the coils 113. Accordingly, when a current is applied to the coils 113, the tilt frame 112 is pivotally moved about the support shaft 111 by an electromagnetic force generated in the coils 113, and the mirror 150 and the transparent plate 160 are pivotally moved with the tilt frame 112.

Further, in the assembled state shown in FIG. 4B, the dispositions and the polarities of the two pan magnets 133 are adjusted so that a force for pivotally moving the pan frame 121 about the support shaft 122 is generated by application of a current to the pan coil 123. Accordingly, when a current is applied to the pan coil 123, the pan frame 121 is pivotally moved about the support shaft 122 by an electromagnetic force generated in the pan coil 123, and the mirror 150 and the transparent member 160 are pivotally moved with the pan frame 121.

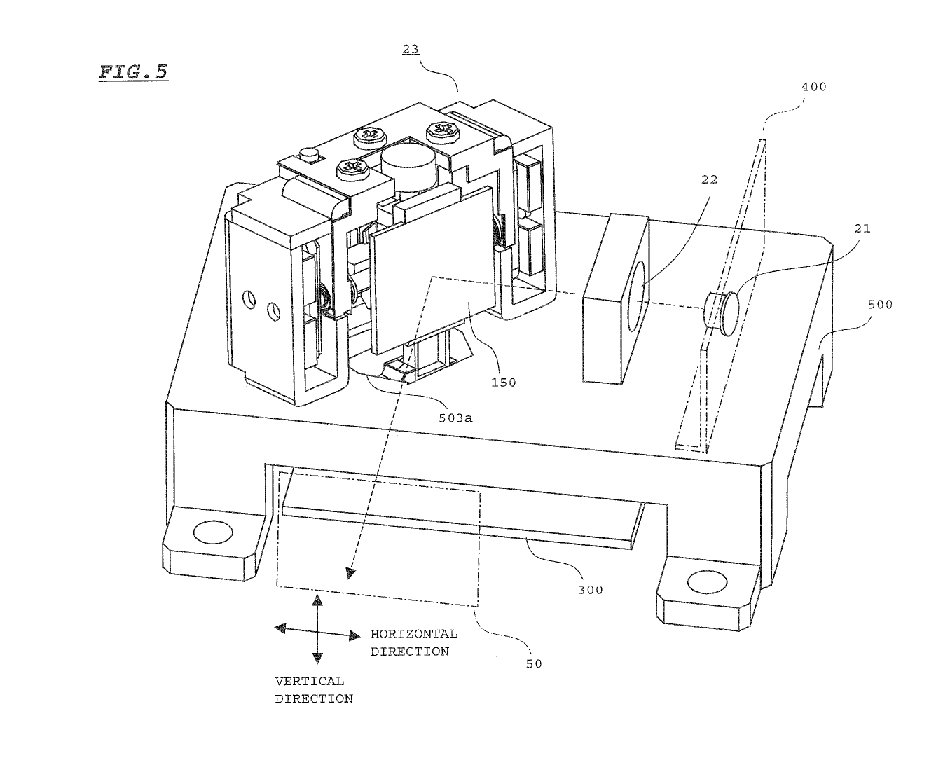

FIG. 5 is a diagram showing an arrangement of an optical system in a state that the mirror actuator 23 is mounted.

Referring to FIG. 5, the reference numeral 500 indicates a base plate for supporting an optical system. The base plate 500 is formed with an opening 503a at a position where the mirror actuator 23 is installed. The mirror actuator 23 is mounted on the base plate 500 in such a manner that the transparent plate 160 is received in the opening 503a.

The laser light source 21 and the beam shaping lens 22 are disposed on a top surface of the base plate 500. The laser light source 21 is mounted on a laser light source circuit board 400 disposed on the top surface of the base plate 500.

Laser light emitted from the laser light source 21 is converged in horizontal direction and in vertical direction by the beam shaping lens 22, and is shaped into a predetermined form in a targeted area. Laser light transmitted through the beam shaping lens 22 is entered into the mirror 150 of the mirror actuator 23, and is reflected on the mirror 150 toward the targeted area. Laser light is scanned in the targeted area by driving the mirror 150 by the mirror actuator 23.

The mirror actuator 23 is disposed at such a position that scanning laser light from the beam shaping lens 22 is entered into the mirror surface of the mirror 150 at an incident angle of 45 degrees with respect to the horizontal direction, when the mirror 150 is set to a neutral position. The term “neutral position” indicates a position of the mirror 150, wherein the mirror surface is aligned in parallel to the vertical direction, and scanning laser light is entered into the mirror surface at an incident angle of 45 degrees with respect to the horizontal direction.

A circuit board (not shown) for supplying a drive signal to the coils 113 and 123 of the mirror actuator 23 is disposed behind the mirror actuator 23, on the top surface of the base plate 500, in addition to a circuit board 400 and other members. Further, a circuit board 300 is disposed underneath the base plate 500, and circuit boards 301 and 302 are disposed on a side surface and a back surface of the base plate 500.

These circuit boards are included in the circuit unit 40 shown in FIG. 1A.

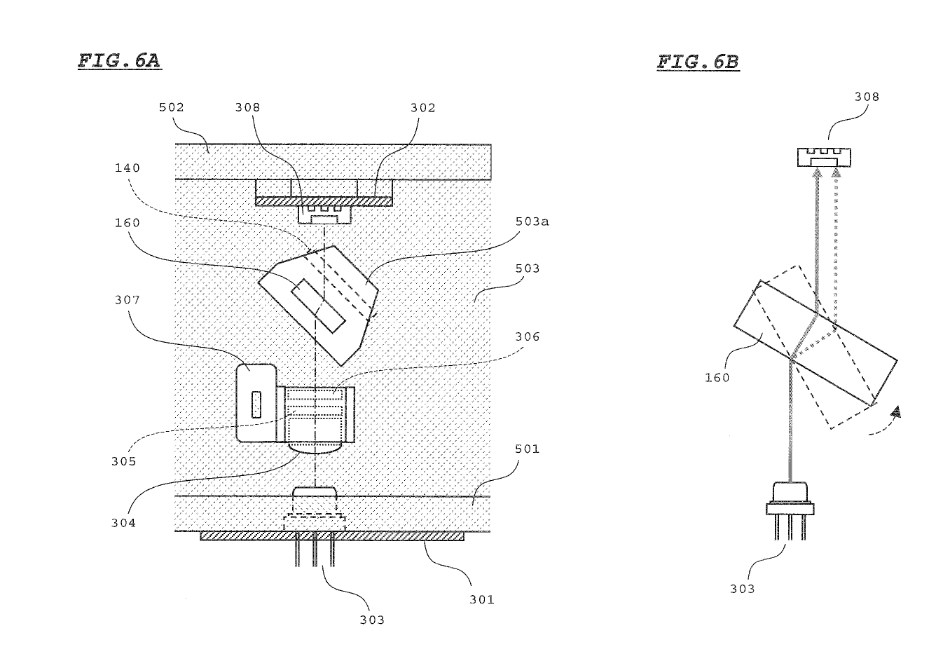

FIG. 6A is a partial plan view of the base plate 500, viewed from the back side of the base plate 500. FIG. 6A shows a part of the back surface of the base plate 500, i.e. a vicinity of the position where the mirror actuator 23 is mounted.

As shown in FIG. 6A, walls 501 and 502 are formed on the periphery of the back surface of the base plate 500. A flat surface 503 lower than the walls 501 and 502 is formed in a middle portion of the back surface of the base plate 500 with respect to the walls 501 and 502. The wall 501 is formed with an opening for receiving a semiconductor laser 303. The circuit board 301 loaded with the semiconductor laser 303 is attached to an outer side surface of the wall 501 in such a manner that the semiconductor laser 303 is inserted in the opening of the wall 501. Further, the circuit board 302 loaded with a PSD (Position Sensitive Detector) 308 is attached to a position near the wall 502.

A light collecting lens 304, an aperture 305, and a ND (neutral density) filter 306 are mounted on the flat surface 503 on the back surface of the base plate 500 by an attachment member 307. The flat surface 503 is formed with an opening 503a, and the transparent plate 160 mounted on the mirror actuator 23 is projected from the back surface of the base plate 500 through the opening 503a. In this example, when the mirror 150 of the mirror actuator 23 is set to the neutral position, the transparent plate 160 is set to such a position that the two flat surfaces of the transparent member 200 are aligned in parallel to the vertical direction, and are inclined with respect to an optical axis of emission light from the semiconductor laser 303 by 45 degrees.

Laser light (hereinafter, called as “servo light”) emitted from the semiconductor laser 303 transmitted through the light collecting lens 304 has the beam diameter thereof reduced by the aperture 305, and has the light intensity thereof reduced by the ND filter 301. Thereafter, the servo light is entered into the transparent plate 160, and subjected to refraction by the transparent plate 160. Thereafter, the servo light transmitted through the transparent plate 160 is received by the PSD 308, which, in turn, outputs a position detection signal depending on a light receiving position of servo light.

FIG. 6B is a diagram schematically showing how the pivotal position of the transparent plate 160 is detected by the PSD 308.

Servo light is refracted by the transparent plate 160 disposed with an inclination with respect to an optical axis of laser light. In this arrangement, when the transparent plate 160 is pivotally moved from the broken-line position in the arrow direction, the optical path of servo light is changed from the dotted-line position to the solid-line position in FIG. 6B, and the light receiving position of servo light on the PSD 308 is changed. With this operation, the moving position of the transparent plate 160 can be detected based on the light receiving position of servo light detected by the PSD 308. Then, the scanning position of scanning laser light in the targeted area can be detected, based on the moving position of the transparent plate 160.

When a targeted area is scanned with laser light, the circuit unit 40 shown in FIG. 1A constantly turns on the semiconductor laser 303. In this way, the scanning position of laser light in the targeted area is detected, based on a detection signal to be inputted from the PSD 308. Then, the mirror actuator 23 is controlled in such a manner that laser light follows a predetermined trajectory on the targeted area, based on a detection result from the PSD 308. Specifically, the circuit unit 40 controls the mirror actuator 23 in such a manner that servo light follows a target trajectory defined on the light receiving surface of the PSD 308.

Further, the circuit unit 40 controls the laser light source 21 to emit laser light at a timing at which the scanning position of laser light has reached a predetermined position.

Then, as described above, presence or absence of an obstacle at the scanning position is detected, based on a signal from the photodetector 33 at the emission timing, and a distance to the obstacle is measured.

In this embodiment, the swing angle of laser light for scanning a targeted area is set to ±20 degrees in horizontal direction, and ±5 degrees in vertical direction. With this arrangement, the incident angle of laser light to be entered into the emission window 50 is set to about 20 degrees as a maximum value. In this embodiment, an anti-reflection film is formed on each of the incident surface and the output surface of the emission window 50 to suppress a reflectance in the incident angle range up to 20 degrees.

FIGS. 7A and 7B are diagrams for describing an arrangement of an anti-reflection film 51 formed on the emission window 50.

As shown in FIG. 7A, the anti-reflection film 51 is formed on each of the incident surface and the output surface of the emission window 50. The anti-reflection film 51 has a multilayer structure, and the characteristics of the anti-reflection film 51 are changed depending on the wavelength and the incident angle of laser light to be entered. Specifically, the wavelength range and the incident angle range capable of suppressing reflection are changed by changing e.g. the thickness of each layer of the anti-reflection film 51.

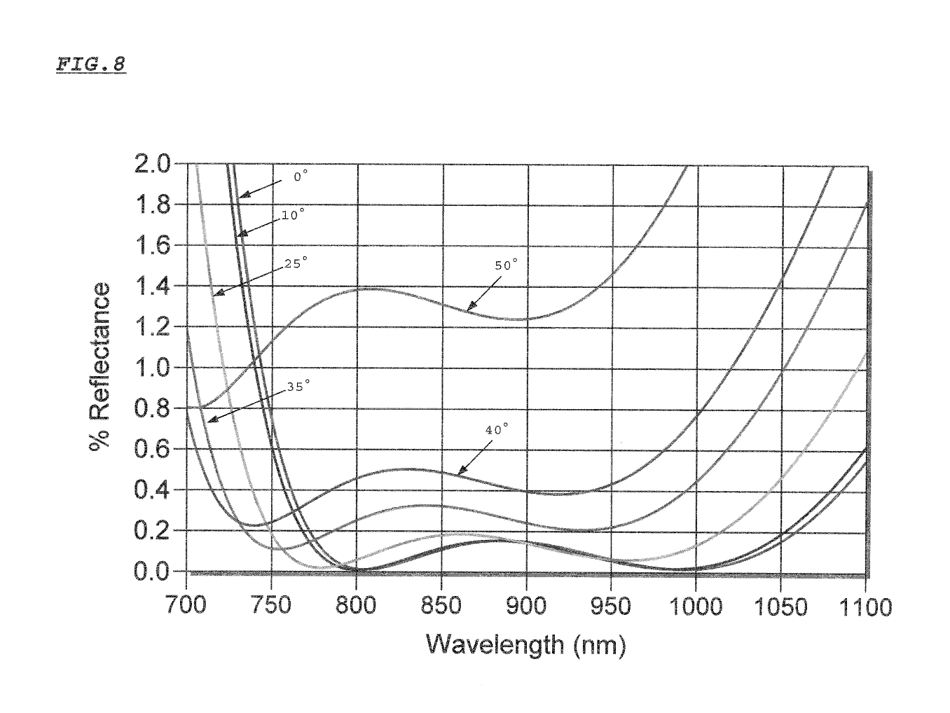

FIG. 8 exemplarily shows characteristics of the anti-reflection film 51, in the case where the anti-reflection film 51 is formed to lower the reflectance with respect to laser light of a wavelength of or about 900 nm. The characteristics shown in FIG. 8 are reflectance characteristics of the emission window 50, in the case where the anti-reflection film 51 is formed on each of the incident surface and the output surface of the emission window 50. The emission window 50 is made of a polymer under the trade name “ZEONEX 480R” of ZEON CORPORATION. The thickness of the emission window 50 is 2 mm.

In the characteristics shown in FIG. 8, the reflectance in the incident angle range of from 0° to 25° is suppressed to about 0.15% near the wavelength of 900 nm of laser light to be used in this embodiment. Further, the reflectance in the incident angle range of from 0° to 25° is uniformly lowered, even if the wavelength of laser light is longer than 900 nm resulting from temperature rise of the laser light source 21.

As described above, it is possible to suppress internal reflection of the emission window 50 in the swing angle range (0°±20°) of laser light, and to keep the beam profile of laser light in a targeted area satisfactory by forming the anti-reflection film 51 having the characteristics shown in FIG. 8 on each of the incident surface and the output surface of the emission window 50.

FIG. 7B is a graph showing a relationship between angle and reflectance at a wavelength of 900 nm, based on the characteristics shown in FIG. 8. The reflectances when the incident angle is 0°, 10°, 25° are respectively 0.141. 0.141. 0.148. As described above, the anti-reflection film 51 is formed in such a manner that the lower limit of the reflectance is substantially kept in the swing angle range of laser light at the use wavelength (900 nm) of laser light in this embodiment. With this arrangement, it is possible to suppress internal reflection of the emission window 50, and to keep the beam profile of laser light in a targeted area satisfactory in scanning laser light.

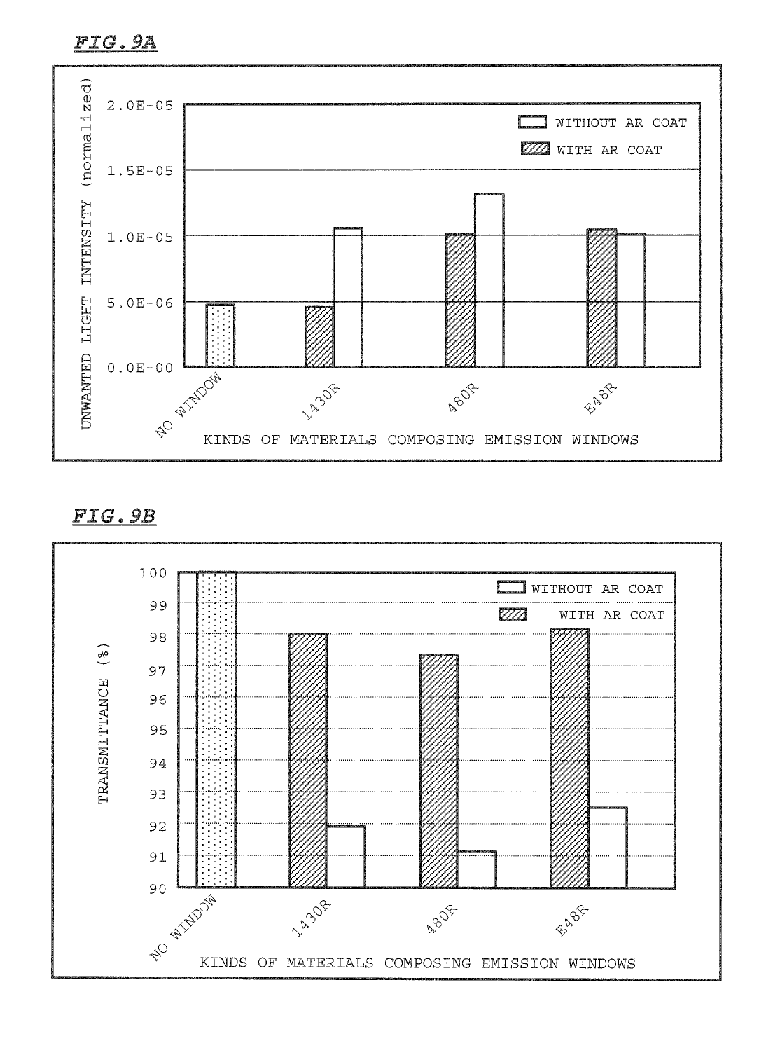

FIG. 9A shows a measurement result on the emission windows 50 made of materials of various kinds, showing as to how the beam profile of laser light is changed by forming the anti-refection film 51 on the emission window 50. FIG. 9B shows a measurement result on the emission windows 50 made of materials of various kinds, showing as to how the transmittance of the emission window 50 is changed by forming the anti-reflection film 51 on the emission window 50. A measurement result (a bar graph of “no window” in each of the drawings of FIGS. 9A and 9B) devoid of the emission window 50 is also shown in each of the measurement results.

In each of the drawings of FIGS. 9A and 9B, the hatched bar graphs indicate a measurement result, in the case where the anti-reflection film 51 is formed on the incident surface and the output surface of the emission window 50; and the blank bar graphs indicate a measurement result, in the case where the anti-reflection film 51 is not formed. The emission windows 50 to be measured are emission windows 50 made of materials of three kinds, i.e., “ZEONEX 480R”, “ZEONEX E48R”, “ZEONOR 1430R”. Further, the anti-reflection film 51 is configured in such a manner that the emission window 50 has characteristics analogous to the characteristics shown in FIG. 8.

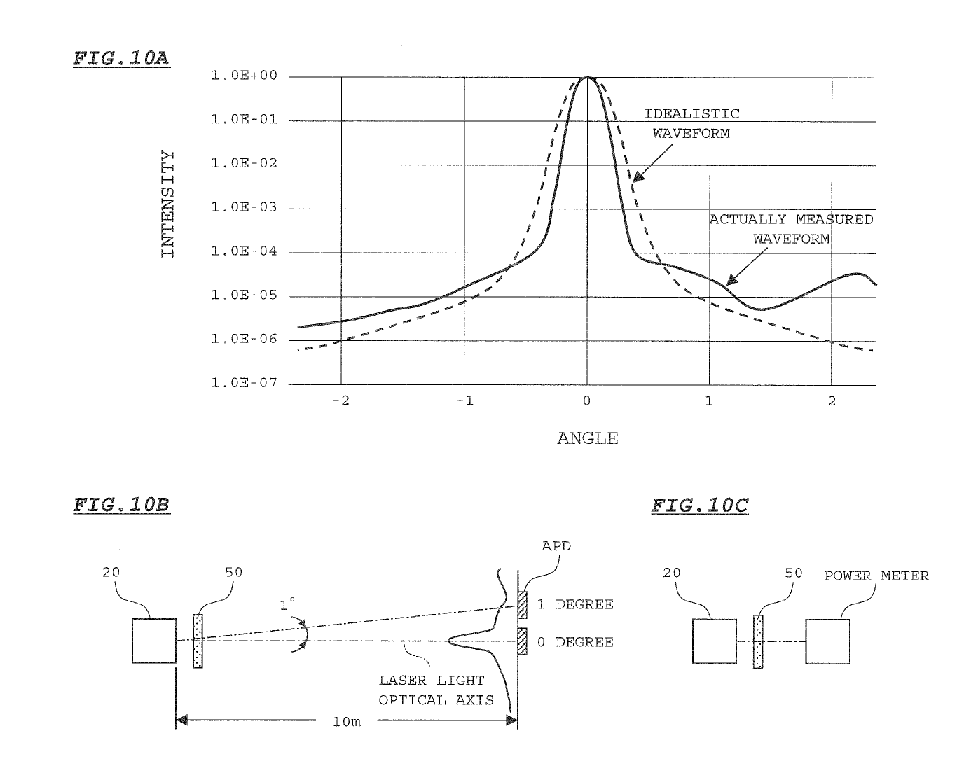

Beam profile measurement was carried out using the arrangement shown in FIG. 10B. Specifically, laser light was emitted from the projection optical system 20, and the intensity of laser light at a position distanced from the projection optical system 20 by 10 m was measured by avalanche photodiode (APD). In the measurement, the mirror 150 of the mirror actuator 23 was fixedly set at a neutral position. The intensity of laser light was measured in a condition (peak measurement value) that the center of the APD was aligned with the optical axis center of laser light, and in a condition (unwanted light measurement value) that the center of the APD was positioned at a position displaced from the optical axis center of laser light by 1°. The wavelength of laser light was set to 905 nm, and the emission power of the laser light source 21 was set to 60 w. Further, the divergence of laser light devoid of the emission window 50 was adjusted such that the beam shape at a position distanced from the position of the emission window 50 by 100 m had an elliptical shape of 2 m in longitudinal direction and 0.2 m in transverse direction.

The measurement result shown in FIG. 9A indicates a ratio of unwanted light measurement value to peak measurement value (unwanted light intensity=unwanted light measurement value/peak measurement value). The measurement result also verifies the beam profile degradation as follows.

FIG. 10A is a diagram showing an example of a change in the received light intensity on the APD with respect to an angular position, in the case where the APD is gradually shifted from the optical axis center in a direction perpendicular to the optical axis, with respect to the measurement result shown in FIG. 10B.

As shown by the broken line in FIG. 10A, an idealistic beam profile is such that the waveform representing a laser light intensity is symmetrical in transverse direction, and is changed with a normal distribution. On the other hand, as shown by the solid line in FIG. 10A, if the beam profile is degraded, the waveform is distorted. In the solid line state shown in FIG. 10A, as compared with the broken line state shown in FIG. 10A, the ratio of intensity (unwanted light measurement value) at the angle of 1° is increased with respect to the intensity (peak measurement value) at the angle of 0°. As described above, generally, if the waveform is distorted, the ratio of unwanted light measurement value to peak measurement value (unwanted light measurement value/peak measurement value) is increased. Accordingly, as shown in FIG. 9A, it is also possible to verify beam profile degradation by evaluating the ratio of unwanted light measurement value to peak measurement value (unwanted light measurement value/peak measurement value).

Transmittance measurement was carried out using the arrangement shown in FIG. 10C. Specifically, a power meter was installed at such a position as to face an output port of the projection optical system 20, and the intensity of laser light to be emitted from the projection optical system 20 was measured by the power meter. In the measurement, measurement values were obtained in the case (non-attenuated value) where the emission window 50 was interposed between the projection optical system 20 and the power meter, and in the case (attenuated value) where the emission window 50 was not interposed, and the transmittance of the emission window 50 was obtained by the ratio of attenuated value to non-attenuated value (attenuated value/non-attenuated value).

Referring to FIG. 9A, it is clear that the unwanted light intensity (unwanted light measurement value/peak measurement value) is suppressed in the emission windows 50 made of “ZEONEX 480R” and “ZEONOR 1430R” by forming the anti-reflection film 51 on each of the incident surface and the output surface of the emission windows 50. Specifically, it is clear that optical characteristics (beam profile) of laser light are improved by forming the anti-reflection film 51 on each of the incident surface and the output surface of the emission windows 50 made of these materials. In particular, optical characteristics (beam profile) of laser light are remarkably improved in the emission window 50 made of “ZEONOR 1430R”, and substantially the same optical characteristics as the case devoid of the emission window 50 can be realized. Thus, “ZEONOR 1430R” may be a most preferable material for the emission window 50 among the three kinds of materials to be measured.

Further, in the case where “ZEONEX 480R” is used, although optical characteristics (beam profile) of laser light are not significantly improved as compared with the case where “ZEONOR 1430R” is used, the transmittance of the emission window 50 is remarkably improved, as is clearly shown in FIG. 9B. Thus, it is possible to enhance the intensity of laser light to be irradiated onto a targeted area.

In the measurement, improvement on optical characteristics (beam profile) of laser light was hardly observed, in the case where “ZEONEX E48R” was used. In the above case, however, as is clearly shown in FIG. 9B, it is also possible to enhance the intensity of laser light to be irradiated onto a targeted area, because the transmittance of the emission window 50 is remarkably improved.

As described above, in this embodiment, it is possible to make optical characteristics (beam profile) of laser light to be irradiated onto a targeted area satisfactory by using a material having a high transparency as a material for the emission window 50, setting the surface roughness and the haze value of the emission window 50 to small values, and forming the anti-reflection film 51 on each of the incident surface and the output surface of the emission window 50.

In particular, it is possible to make optical characteristics (beam profile) of laser light satisfactory, and to enhance the detection precision of an obstacle in the targeted area, while enhancing the intensity of laser light to be irradiated onto a targeted area, by forming the anti-reflection film 51 on each of the incident surface and the output surface of the emission window 50. Use of “ZEONOR 1430R” as a material for the emission window 50 enables to realize optical characteristics (beam profile) substantially the same as the case devoid of the emission window 50.

Further, in this embodiment, the anti-reflection film 51 is so configured as to keep the lower limit of the reflectance in the incident angle range of laser light at least corresponding to the laser light scanning range (0°±20°). With this arrangement, it is possible to suppress degradation of optical characteristics of laser light resulting from internal reflection of the emission window 50 at any scanning position.

### Modification

In the embodiment, internal reflection of the emission window 50 is suppressed by forming the anti-reflection film 51 on each of the incident surface and the output surface of the emission window 50. In the modification, internal reflection of the emission window 50 is suppressed by forming a fine periodic structure on each of the incident surface and the output surface of the emission window 50. The arrangement of the light receiving window 60 is substantially the same as the arrangement of the emission window 50.

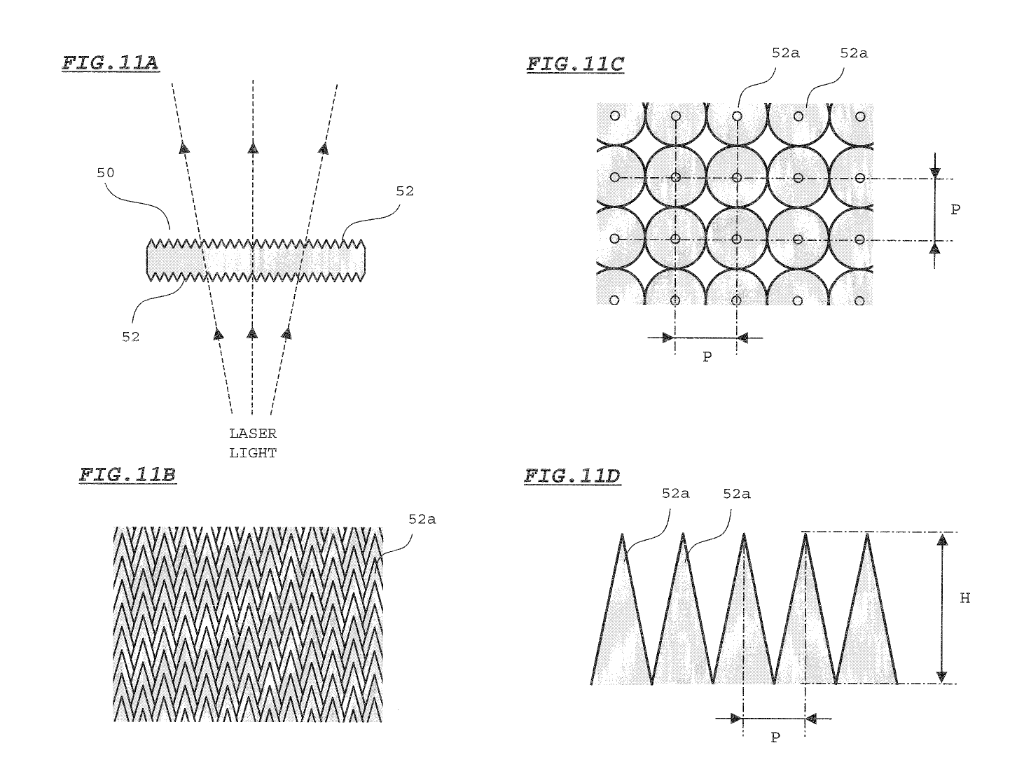

FIG. 11A is a diagram showing an arrangement of the emission window 50 as a modification. A fine periodic structure 52 is formed on the laser light incident surface and the laser light output surface of the emission window 50. With the formation of the periodic structure 52, laser light reflection on the incident surface and the output surface of the emission window 50 is suppressed. The material, the surface roughness, the haze value, and a like parameter of the emission window 50 are substantially the same as those in the embodiment.

FIG. 11B is a perspective view schematically showing as to how the periodic structure 52 is formed. FIGS. 11C and 11D are respectively a plan view and a side view schematically showing as to how the periodic structure 52 is formed.

As shown in FIG. 11D, the periodic structure 52 is configured such that projections 52a each having a tapered conical shape with a predetermined height H are arranged at a predetermined pitch P. The projections 52a are called as an anti-reflection structure, and have a tapered conical shape. Alternatively, the projection 52a may have e.g. a pyramidal shape, in place of the conical shape as shown in FIG. 11D. The periodic structure 52 may be formed by e.g. transfer from a mold by injection molding.

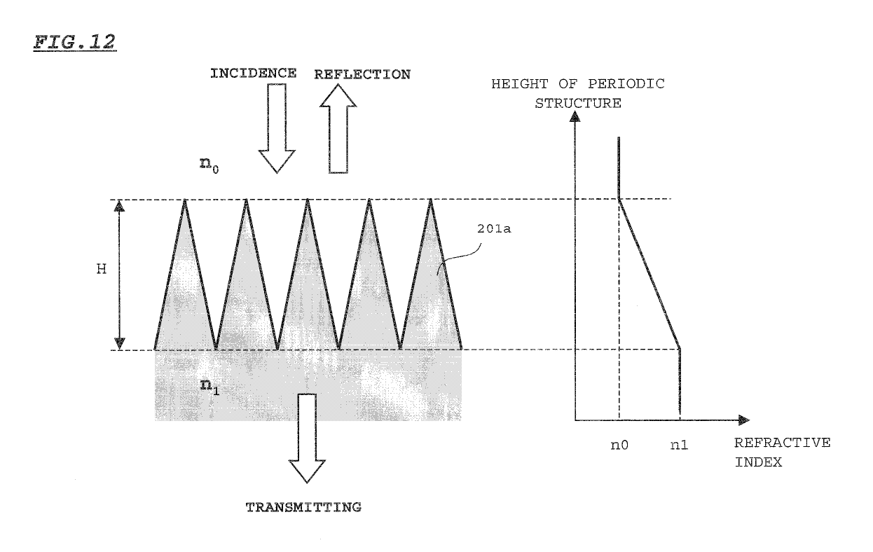

FIG. 12 is a diagram showing a relationship between the periodic structure 52 and a refractive index. As shown in FIG. 12, in the case where the periodic structure 52 is formed on a medium having the refractive index n1, the effective refractive index on the light incident surface of the medium is moderately changed, and apparently, there is no refractive index boundary between two media (having the refractive indexes of n0, n1). With this arrangement, it is possible to suppress the reflectance on the light incident surface of the medium having the refractive index n1. The above phenomenon occurs, in the case where the pitch of the periodic structure 52 in the in-plane direction of the light incident surface is smaller than the wavelength of incident light.

Accordingly, establishing the expression: P≦λ/n, where P is the pitch of the projections 52a on the periodic structure 52, n is the refractive index of a material, and λ is the wavelength of laser light, enables to suppress reflection of laser light on the incident surface and the output surface of the emission window 50. In the modification, the pitch P of the periodic structure 52 formed on each of the incident surface and the output surface of the emission window 50 is determined to satisfy the expression: P≦λ/n, in view of the above aspect.

In the modification, since the reflection suppressing function of the periodic structure 52 is substantially kept unchanged without depending on the incident angle of laser light, it is possible to suppress degradation of optical characteristics of laser light resulting from inner reflection of the emission window 50 at any laser light scanning position, as well as the embodiment.

The embodiment of the invention has been described as above. The invention is not limited to the foregoing embodiment, and the embodiment of the invention may be modified in various ways other than the above.

For instance, in the embodiment, there has been described an arrangement example of a mirror actuator configured such that a mirror is rotated about two axes. Alternatively, the invention may be applicable to a mirror actuator having an arrangement other than the above arrangement, an actuator of a type such that laser light is scanned by driving a lens, or an actuator incorporated with a polygonal mirror.

In the embodiment and the modification, the light receiving window 60 has substantially the same arrangement as the arrangement of the emission window 50. Alternatively, the light receiving window 60 may be devoid of the anti-reflection film 51. Further alternatively, the light receiving window 60 may be made of a material other than the above. Further alternatively, the surface roughness and the haze value of the light receiving window 60 may be the ones other than the above.

Further alternatively, a filter may be disposed on the back surface side of the emission window 50 to prevent intrusion of external light into the housing 10 through the emission window 50 and the opening 11. The above filter is a band-pass filter for transmitting only light of a wavelength region of laser light to be emitted from the laser light source 21, as well as the light-receiving-side filter 31. With this arrangement, it is possible to prevent external light of a wavelength near the wavelength of servo light from reaching the PSD 308, which may adversely affect control of the mirror actuator 23. In the above arrangement, the emission window 50 itself may have filter characteristics substantially the same as the characteristics of the filter 31.

Furthermore, the wavelength region of laser light may be changed to a range other than the range described in the embodiment, as necessary. In the case where the wavelength region of laser light is changed from the one described in the embodiment, the characteristics of the anti-reflection film 51 may also be modified to be in conformity with the changed wavelength region.

The embodiment of the invention may be changed or modified in various ways as necessary, as far as such changes and modifications do not depart from the scope of the present invention hereinafter defined.

What is claimed is:

1. A beam irradiation device, comprising:
a laser light source which emits laser light;
an actuator which causes the laser light to scan a targeted area; and
an emission window through which the laser light via the actuator is transmitted, wherein
the emission window is formed with reflection suppressing means for suppressing surface reflection.

2. The beam irradiation device according to claim 1, wherein
the reflection suppressing means includes an anti-reflection film, and
the anti-reflection film has an angle dependence such that a lower limit of a reflectance is maintained in an incident angle range of the laser light at least corresponding to a scanning range of the laser light.

3. The beam irradiation device according to claim 1, wherein
the reflection suppressing means includes a periodic structure having a pitch that satisfies the following expression:
P≦λ/n
where P is the pitch, λ is the wavelength of the laser light, and n is the refractive index of the emission window.

4. The beam irradiation device according to claim 3, wherein
the periodic structure is made of a plurality of projections each having a tapered conical shape.

5. The beam irradiation device according to claim 1, wherein
the reflection suppressing means is formed on both of an incident surface and an output surface of the emission window.

6. A laser radar system, comprising:
the beam irradiation device; and
a light receiving portion which receives the laser light reflected on the targeted area, wherein
the beam irradiation device comprises:
a laser light source which emits laser light;
an actuator which causes the laser light to scan a targeted area; and
an emission window through which the laser light via the actuator is transmitted, wherein
the emission window is formed with reflection suppressing means for suppressing surface reflection.

7. The laser radar system according to claim 6, wherein
the reflection suppressing means includes an anti-reflection film, and
the anti-reflection film has an angle dependence such that a lower limit of a reflectance is maintained in an incident angle range of the laser light at least corresponding to a scanning range of the laser light.

8. The laser radar system according to claim 6, wherein
the reflection suppressing means includes a periodic structure having a pitch that satisfies the following expression:
P≦λ/n
where P is the pitch, λ is the wavelength of the laser light, and n is the refractive index of the emission window.

9. The laser radar system according to claim 8, wherein
the periodic structure is made of a plurality of projections each having a tapered conical shape.

10. The laser radar system according to claim 6, wherein
the reflection suppressing means is formed on both of an incident surface and an output surface of the emission window.
